(19) United States
(12) Patent Application Publication
(10) Pub. No.: US 2002/0067817 A1
(43) Pub. Date: Jun. 6, 2002

(54) METHOD AND APPARATUSFOR USE WITH AN INTELLIGENT NETWORK

(76) Inventors: MARCOS H. CANIHUANTA, TINTON FALLS, NJ (US); JAMES M. CARNAZZA, RUMSON, NJ (US); MORTEZA GHASSEMI, WEST LONG BRANCH, NJ (US); TUNG-HAI HSIAO, HOLMDEL, NJ (US); CYNTHIA J. KARHAN, BRICK, NJ (US); ROMEL KHAN, EATONTOWN, NJ (US); WONSEOK LEE, MIDDLETOWN TOWNSHIP, NJ (US); STEPHANIE PARLAMAS, WAYSIDE, NJ (US)

Correspondence Address: SAMUEL H DWORETSKY, AT&T CORP, P O BOX 4110, MIDDLETOWN, NJ, 077484801

(21) Appl. No.: 09/167,289

(22) Filed: Oct. 6, 1998

(51) Int. Cl. H04M 1/64; H04M 7/00

(52) U.S. Cl. 379/219

(57) ABSTRACT

Systems and methods provide service on a network, receiving from a database a response to a query, processing the response to obtain a set of instructions that are adapted to be executable by a switch, and then controlling the switch in accordance with the instructions.

### CROSS-REFERENCE TO RELATED APPLICATIONS

This application relates to commonly assigned U.S. application Ser. No. 08/844,424, filed Apr. 18, 1997 and entitled “Method And System For Implementing Intelligent Telecommunication Services Utilizing Self-Sustaining, Fault-Tolerant Object Oriented Architecture,” which is hereby incorporated by reference.

### FIELD OF THE INVENTION

The present invention relates to an interface between network components. In particular, the present invention relates to a method and apparatus for communication between a switch and an incompatible database.

### BACKGROUND

In communications networks, a call is typically received by a network switch that contains the intelligence necessary for performing various functions. While these switches contain circuits for performing defined tasks, however, the switches do not necessarily store all the logic and information necessary to perform every service-specific function. As a result, the switches must act in conjunction with databases distributed throughout the network to complete calls with the needed service features.

As an example, current toll-free service uses a switch-and-database combination to connect a caller to a called party. Typically, the caller dials, for example, an “800” number, and the switch then receives this 800 number. The switch then queries the relevant database to match the 800 number with the actual telephone number or network address of the called party. The database then returns the actual telephone number to the switch and the switch completes the call. The 800 number in this scenario is an address that tells the switch where on the database to look for the caller's phone number.

In another example of the prior art, there is an application whereby the database return two numbers to the switch with instructions to the switch to route the call to the first number, and if the first number is busy or not answered, then to route the call to the second number. In a more complex case, a database, in addition to passing the routing number, can ask a switch to play announcements, collect digits from the calling party, or route to different places based, inter alia, on the digits collected. These functions work because the relevant switch has the intelligence to perform these functions.

Currently, a trend exists in the industry to make switches less intelligent, and there are new protocols and ways of working with switches that are intended to implement this trend. For example, one new protocol is BellCore's Advanced Intelligent Network (“AIN”). Another example is the ITU-T Intelligent Network (“IN”). As these switches change to new ways of working, and the databases do not change, the combination of new switch and old database may prevent the network from offering improved functionality because the switches may not contain the logic to perform the functions.

Within an intelligent network architecture, switches can be used in connection with a service node. A service node is a processor in the intelligent network architecture that has a bearer connection (i.e., a voice circuit) to a switch, typically over an ISDN line. The service node contains service logic that is executed when a switch terminates the call to the service node. A service node may also connect to a database to access certain customer records or service (or control) logic when the data and/or service (or control) logic is distributed between the service node and the database. The service node, however, is incapable of translating or adapting instructions for the benefit of the switch. Rather, the service node acts as a switch and executes the instructions itself.

Consider as an example, although not the only example, a switch and a database. The switch in this example is required to receive information from a database and to perform various functions. It is assumed that the switch has the requisite intelligence to perform these functions. Consider FIG. 1, a system overview of a prior-art system. In this example, user 101 places a call to receiver 105. User 101 connects to switch 102, which then queries database 103 to return two possible numbers to switch 102. In the prior art, switch 102 attempts to connect to one of the returned numbers, and if there is no answer, or a busy signal is received, switch 102 knows to attempt connection with the other returned number.

In this example, as in others, it is necessary that the switch have the requisite intelligence to perform the function. If the switch does not, or if the switch's call-processing procedures (i.e., call models) are different from the database's view of the switch-call-processing procedures, the switch will not be able perform the desired function.

### SUMMARY OF THE INVENTION

To alleviate the problems in the prior art, the present invention introduces systems and methods for providing service on a network, comprising receiving from a database a response to a query, processing the response to obtain a set of instructions that are adapted to be executable by a switch, and then controlling the switch in accordance with the instructions.

### BRIEF DESCRIPTION OF THE DRAWINGS

FIG. 1 is a block diagram of a system overview of a prior-art system.

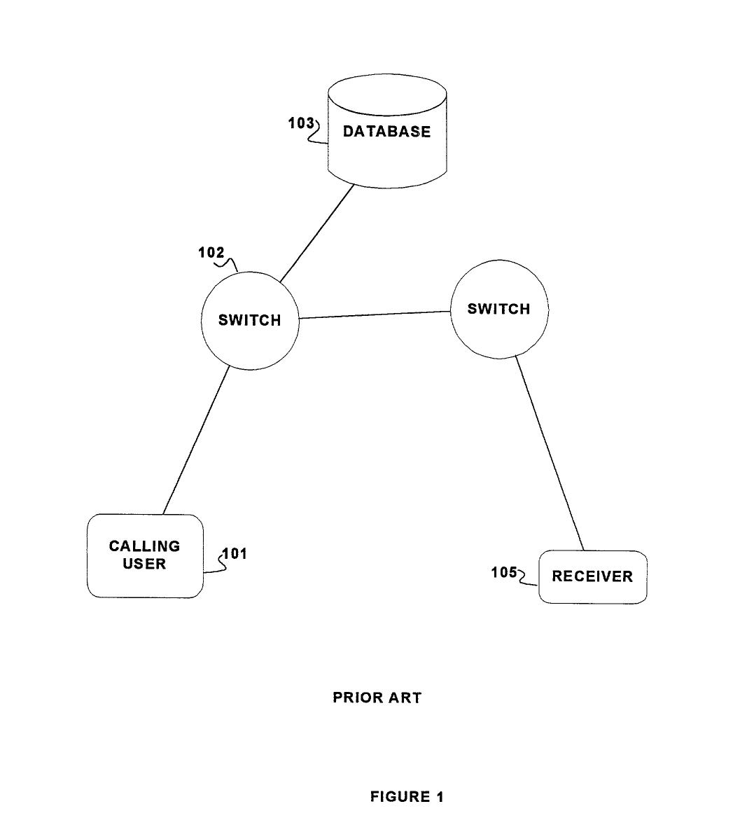

FIG. 2 is a block diagram of a system overview of an embodiment of the present invention.

FIG. 3 is a flow chart of an embodiment of a method of practicing the present invention.

FIG. 4 is a block diagram a system overview of another embodiment of the present invention.

FIG. 5 is a block diagram of an embodiment of the present invention.

FIG. 6 is a block diagram of an embodiment of the present invention.

### DETAILED DESCRIPTION

Embodiments of the present invention are directed to allowing incompatible switches and databases to interact on a network. Until the database's view of switch-call-processing procedures and the database's service logic are compatible with actual switch-call-processing procedures, the switch does not have the ability to supply the service expected by a user.

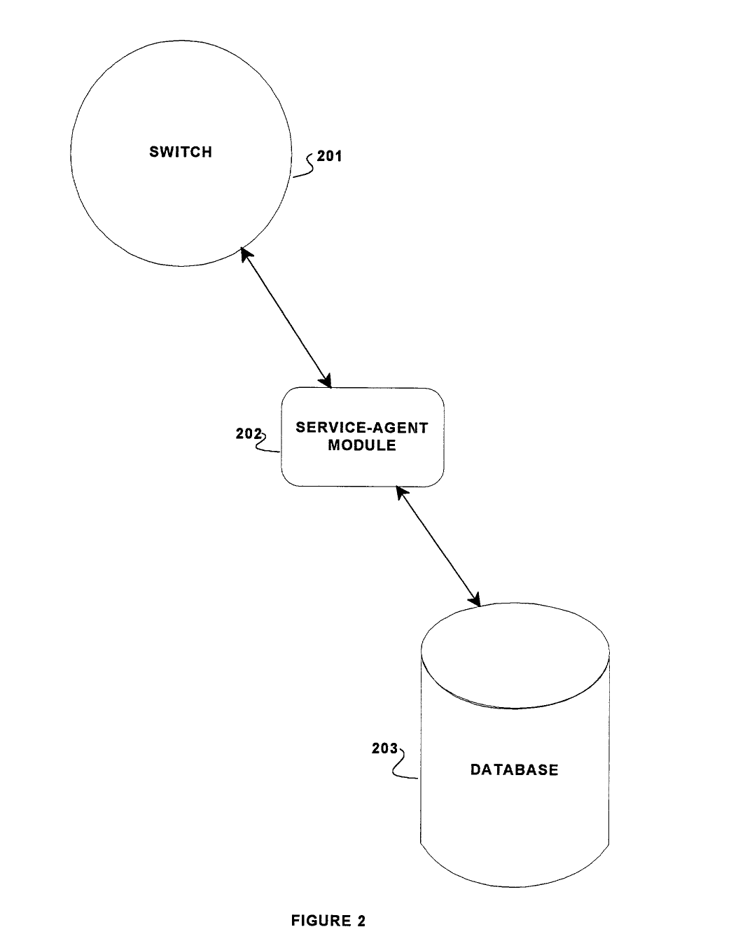

Consider, as an example, but not the only example, a switch that receives a call from a caller who desires to connect to a toll-free number. The switch must know to pass the toll-free number to a database, and then receive instructions from the database about how and where to route the call. In this example, assume that the switch is a new, less intelligent switch, and cannot understand instructions from the database. To solve this problem, a service-agent module is introduced and is placed functionally between the switch and the database; this service-agent module acts to ensure that the caller is receiving the desired service. Turning now to FIG. 2, we see an example of a system overview of an embodiment of the present invention. In this example, switch 201 receives a call from a caller, and the call is a toll-free number. Switch 201 then queries database 203, asking for the proper routing number or numbers. Assume database 203 returns two numbers with instructions to the switch to route the call to the first number, and that if the first number is busy, or rings with no answer, to route the call to the second number. If switch 201 does not have the intelligence to understand this chain of operations, service-agent module 202 can act as a go-between, and receive the routing numbers and instructions from the database. Service-agent module 202 in this example knows that switch 201 does not have the ability to either receive two numbers or perform the requisite instructions returned from database 203. Therefore, service-agent module 202 in this example can send the first number to switch 201 with instructions to route the call to the first number, and if the first number is busy, or ringing with no answer, inform service-agent module 202. Service-agent module 202 keeps the second routing number in its memory, and can send the second number to switch 201 with instructions to route the call accordingly.

To perform the above tasks, service-agent module 202 must understand the call-processing procedures of switch 201, and must also understand the service-logic procedures of database 203. Additionally, because switch 201 does not have the intelligence to understand or follow the instruction set supplied by database 203, service-agent module 202 must be able to explain to switch 201 how to perform desired services.

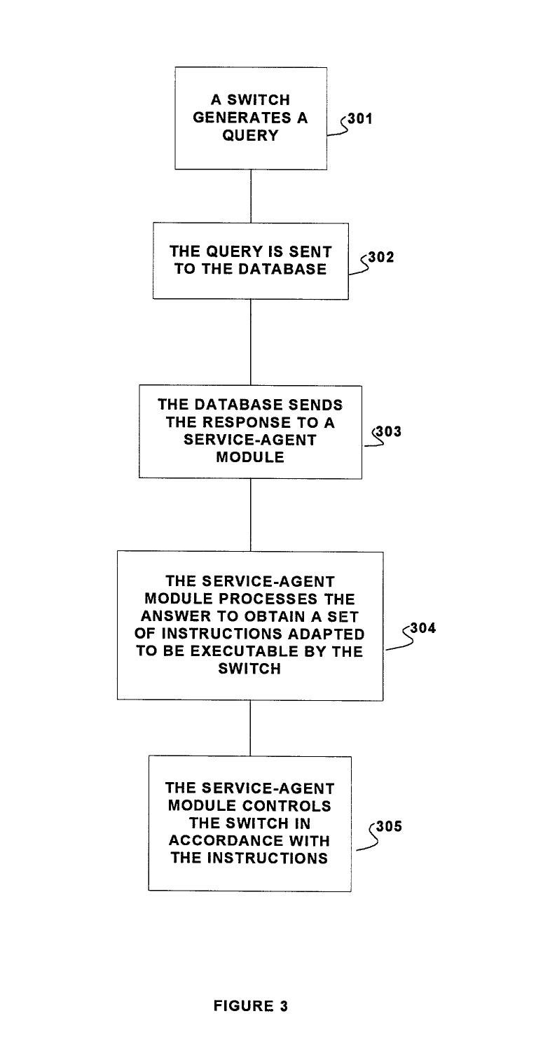

FIG. 3 is a flow chart of a method of practicing the present invention. At step 301, a switch can generate a query, and at step 302, the query is sent to the database. In one embodiment of the present invention, the query can be sent directly to the database. In another embodiment of the present invention, the query can be sent to the database through some functional module such as a service-agent module.

In either embodiment, the database then responds to the query, but does not send the response directly to the switch, because the switch cannot execute the instructions in the form provided in the database response. Therefore, at step 303, the database sends the response to a service-agent module, which receives the response. At this point, at step 304, the service-agent module processes the response to obtain a set of instructions adapted to be executable by a switch. That is, the service-agent module acts as the active service-logic interworker for the switch, and at step 305, the service-agent module controls the switch in accordance with the instructions. In other words, the service-agent module, after creating an instruction set, sends information and instructions to the switch in a way that is understandable by the switch.

As an example, assume the switch queries the database and the database returns two routing numbers with instructions to the switch to route the call to the first routing number, and if the switch receives a non-response, to route the call to the second routing number. Again, the switch does not have the intelligence to perform these instructions in this way, and so the service-agent module intervenes. In this example, the service-agent module receives the two routing numbers and instructions from the database, and the service-agent module then can instruct the switch to route the call to the first routing number. If the switch receives a non-response, the switch informs the service-agent module, which then instructs the switch to route the call to the second routing number.

From this example, one can extrapolate the idea that the database can respond to the query by sending to the service-agent module any information contained within the database, along with instructions to perform a service that correlates with a particular subscriber's desires. For the purposes of the present invention, the word database includes, but is not limited to, an adjunct. Additionally, for the purposes of the present invention, the word switch includes, but is not limited to, a service node.

Note that in the example above the switch queries the database directly, and the database then returns a response to the service-agent module. In one embodiment of the present invention, however, the service-agent module acts as a complete intermediary between the switch and the database. That is, rather than sending a query directly to the database, the switch can send a query first to the service-agent module. The service agent module then either passes the query along unchanged, or first alters the query and subsequently passes along the altered query to the database. The database can then return a response to the service-agent module, and the process can continue as in the other embodiment.

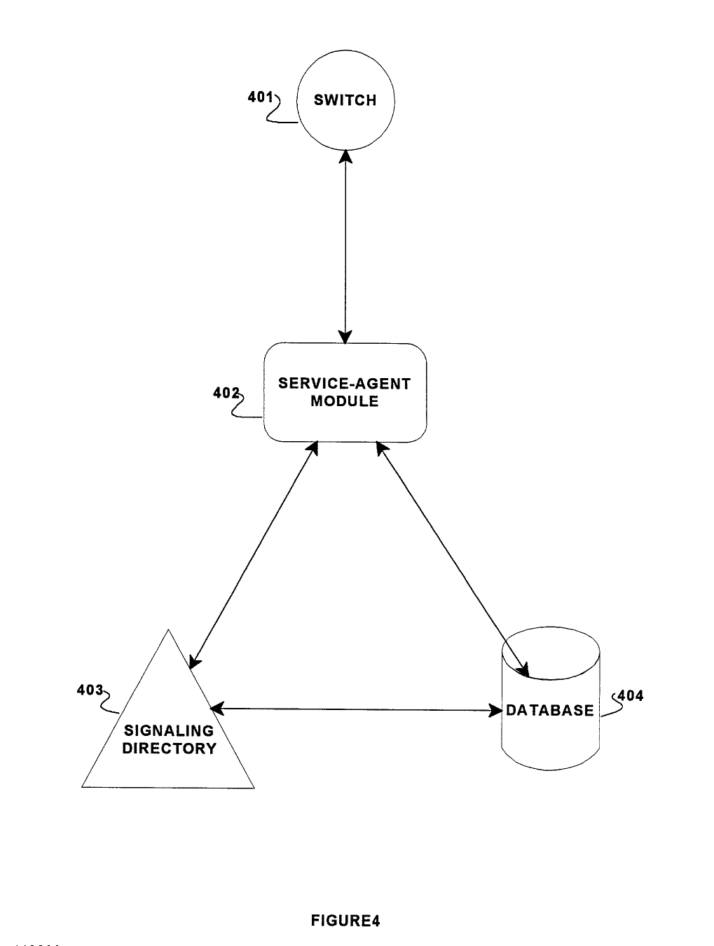

FIG. 4 is a block diagram representing another embodiment of the present invention. In this embodiment, switch 401 sends a query to service-agent module 402, which then passes the query, either altered or unaltered, to signaling directory 403. The signaling directory is described in U.S. Pat. No. 5,473,677, hereby incorporated by reference into this document. Note that, as above, in an alternative embodiment, the switch can query directly signaling directory 403. At this point, signaling directory 403 determines an appropriate database and formulates its own query to the database. The database then returns information and instructions directly to service-agent module 402, and service-agent module 402 is able to identify for which call the database response is through some correlation identification parameter that was passed from signaling directory 403 to the database, and then back to service-agent module 402 with the response.

In one embodiment of the present invention, the correlation identification parameter is generated in service-agent module 402. Service-agent module 402 , as in the previous embodiments, processes the response to obtain an instruction set adapted to be executable by switch 401, and then controls switch 401 in accordance with the instructions. Service agent module 402 keeps time to await a response from signaling directory 403 and the database. Signaling directory 403 may also send certain responses to service-agent module 402. The following is a nonexhaustive list of examples where signaling directory 403 could send a response to service-agent module 402: to refresh the service agent's signaling directory timer; to proceed normally if an appropriate database could not be found; and to query a database directly from the service agent because the links from the signaling directory to the databases are down. Service agent module 402 processes the responses from signaling directory 403 and determines whether it can understand the signaling directory response without involving the switch or whether information needs to be sent to the switch. Then the service agent takes the appropriate actions. In this embodiment, the query to signaling directory 403 may contain a correlation identification and a separate signaling-directory query. The correlation identification and signaling-directory query can be generated by service-agent module 402. In this embodiment, the service-agent module can hide from the switch the presence of the signaling directory in the telecommunication network. Thus, the switch does not have to be able to send the needed specialized queries to a signaling directory that does not conform to the switch's call-processing procedures.

In one embodiment of the present invention, service-agent module 402 can keep the necessary call-state information even after the transaction with the database is closed. For example, consider the case in which a switch queries a database directly. In this case, the database returns two routing numbers to the service-agent module and the database then closes its transaction. The service-agent module then instructs the switch to route to the first routing number, and to inform back to the service-agent module whether this number is busy, or ringing with no answer, or even if the call is answered. The service-agent module in this example keeps the call state information, and if the service-agent module receives information from the switch that the first number is busy or is ringing with no answer, then the service -agent module instructs the switch to route to the second number, and then closes out the transaction. If the switch informs the service-agent module that the first number is answered, the service-agent module can close out the transaction with the switch.

In one embodiment of the present invention, service-agent module 402 stores routing information for toll-free numbers. In another embodiment of the present invention, service-agent module 402 can cache routing number information when service-agent module 402 receives a response from a database. In this embodiment, when a caller dials a toll-free number, a switch sends a query to a database through service-agent module 402. Service-agent module 402 checks for the toll-free information in its memory. If the information is not in memory, then service agent component passes the query to the database. If the information exists in memory, service-agent module 402 retrieves the information and sends it to the switch. In one embodiment of the present invention, the instructions performed by service-agent module 402 can be integrated with a switch.

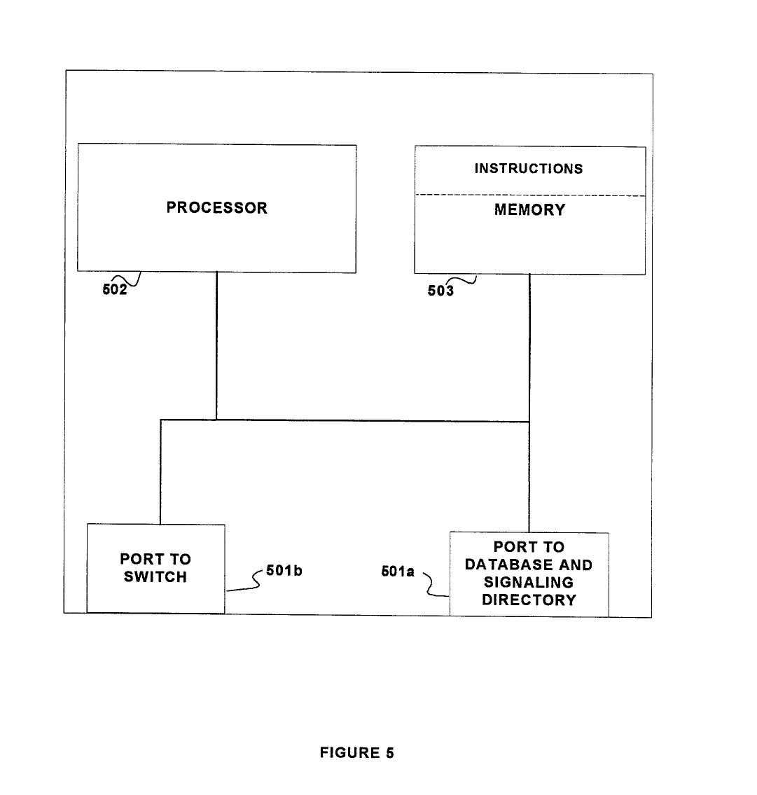

FIG. 5 is an alternate embodiment of the present invention. In this embodiment, queries and instructions are received and sent through ports 501a and 501b. Memory 503 stores instructions adapted to be run on processor 502 to receive a query from a switch through port 501b, send the query to a database (altered or not) through port 501a, receive a response from the database, process the response to obtain a set of instructions that are adapted to be executable by the switch, and then control the switch in accordance with the instructions.

As an example, assume the switch queries the database directly, and the database returns two routing numbers with instructions to route the call to the first routing number, and if the switch receives a non-response, to route the call to the second routing number. Memory 503 stores instructions adapted to be run on processor 502 to receive this response to the query, and then to formulate a set of instructions to control the switch to carry out these instructions. For example, memory 503 can store instructions adapted to be executed by processor 502 to send the first routing number to the switch with instructions to route the call to the first routing number; if the switch receives a non-response, memory 503 can store further instructions adapted to be executed by processor 502 to receive a non-response message from the switch, and to send the second routing number to the switch with instructions to route the call to the second number.

In one embodiment of the present invention, memory 503 stores instructions adapted to be executed by processor 502 to receive information along with instructions to perform a service that correlates with a particular subscriber's desires.

For the purposes of this document, memory includes any medium capable of storing instructions adapted to be executed by a processor. Some examples of such media include, but are not limited to, floppy disks, CDROM, RAM, cache, magnetic tape, hard drives, and any other device that can store digital information. In one embodiment, the instructions are stored on the medium in a compressed and/or encrypted format. As used herein, the phrase “adapted to be executed by a processor” is meant to encompass instructions stored in a compressed and/or encrypted format, as well as instructions that have to be compiled or installed by an installer before being executed by the processor.

In one embodiment of the present invention, memory 503 stores instructions adapted to be executed by processor 502 to send a query to a signaling directory and to receive a response from a signaling directory. In one embodiment of the present invention, the query contains a correlation identification. In another embodiment of the present invention, memory 503 stores instructions adapted to be executed by processor 502 to send a signaling-directory query. In another embodiment of the present invention, memory 503 stores instructions adapted to be executed by processor 502 to generate a signaling-directory query.

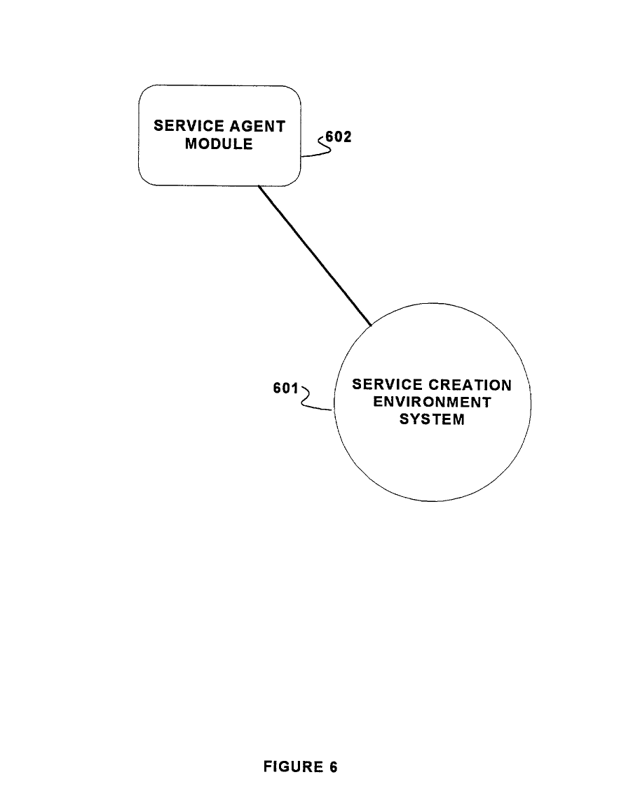

FIG. 6 is a block diagram of another embodiment of the present invention. In this embodiment of the present invention, a service creation environment system 601 is coupled with service-agent module 602. Service creation environment system 601 provides an interface between service-agent module 602 and humans who desire to alter some parameters or functions in the services provided by service-agent module 602. For example, but not the only example, service creation environment system 601 can be a graphical user interface. Assume, for the sake of example, that service-agent module 602 receives two routing numbers from the database and instructs the switch to route the call sequentially to the two routing numbers. A user may now desire that he would like three calls to be routed sequentially, and can, through service creation environment system 601, alter the instructions sent to the database such that the database now returns three routing numbers rather than two routing numbers.

The present invention has been described in terms of several embodiments solely for the purpose of illustration. Persons skilled in the art will recognize from this description that the invention is not limited to the embodiments described, but may be practiced with modifications and alterations limited only by the spirit and scope of the appended claims.

What is claimed Is:

1. A method for providing service on a network, comprising:
(a) receiving from a database a response to a query;
(b) processing the response to obtain a set of instructions that are adapted to control the switch; and
(c) transmitting, to the switch, the set of instructions to control the switch.

2. The method of claim 1, wherein the response received from the database includes a routing number.

3. The method of claim 1, wherein the response received from the database includes information about a subscriber's desired service.

4. The method of claim 1, wherein the database is a network control point, and the response includes at least a first routing number and a second routing number, and wherein the set of instructions includes instructions to
(i) route the call to the first routing number; and
(ii) route the call to the second routing number if the switch receives a non-response.

5. The method of claim 1, further comprising:
(d) receiving the query from the switch;
(e) processing the query to obtain a query that is adapted to be executable by the database; and
(f) sending the processed query to the database.

6. The method of claim 5, wherein the query in step (a) is a query to a signaling directory.

7. The method of claim 5 further comprising
(g) using a service creation environment system to alter service parameters.

8. The method of claim 5, further comprising preserving call-state information after the transaction with the database is concluded.

9. An apparatus for providing service on a network, comprising:
(a) a processor;
(b) a port coupled to said processor; and
(c) a memory, coupled to said processor and said port, storing instructions adapted to be run on said processor to
(i) receive from a database a response to a query;
(ii) process the response to obtain a set of instructions that are adapted to control the switch; and
(iii) transmit, to the switch, the set of instructions to control the switch.

10. The apparatus of claim 9, wherein the response received from the database includes a routing number.

11. The apparatus of claim 9, wherein the response received from the database includes information about a subscriber's desired service.

12. The apparatus of claim 9, wherein the database is a network control point, and the response includes at least a first routing number and a second routing number, and wherein the set of instructions includes instructions to
(a) route the call to the first routing number; and
(b) route the call to the second routing number if the switch receives a non-response.

13. The apparatus of claim 9, wherein said memory stores further instructions to:
(i) receive the query from the switch;
(ii) process the query to obtain a query that is adapted to be executed by the database; and
(iii) send the processed query to the database.

14. The apparatus of claim 13, wherein the query in (i) is a query to a signaling directory.

15. The apparatus of claim 13, wherein said memory stores further instructions adapted to be executed by said processor to
(iv) use a service creation environment system to alter service parameters.

16. The apparatus of claim 13, wherein said memory stores further instructions to preserve call-state information after the transaction with the database is concluded.

17. A computer-readable medium storing instructions adapted to be executed by a processor, comprising:
(a) receiving from a database a response to a query;
(b) processing the response to obtain a set of instructions that are adapted to control the switch; and
(c) transmitting, to the switch, the set of instructions to control the switch.

18. The computer-readable medium of claim 17, wherein the response received from the database includes a routing number.

19. The computer-readable medium of claim 17, wherein the response received from the database includes information about a subscriber's desired service.

20. The computer-readable medium of claim 17, wherein the database is a network control point, and the response includes at least a first routing number and a second routing number, and wherein the set of instructions includes instructions to
(i) route the call to the first routing number; and
(ii) route the call to the second routing number if the switch receives a non-response.

21. The computer-readable medium of claim 17, storing further instructions adapted to be executed by a processor to
(d) receive the query from the switch;
(e) process the query to obtain a query that is adapted to be executable by the database; and
(f) send the processed query to the database.

22. The computer-readable medium of claim 21, wherein the query in step (a) is a query to a signaling directory.

23. The computer-readable medium of claim 21, storing further instructions adapted to be executed by a processor to
(g) use a service creation environment system to alter service parameters.

24. The computer-readable medium of claim 21, storing further instructions adapted to be executed by a processor to preserve call-state information after the transaction with the database is concluded.
